(19) United States
(12) Patent Application Publication
(10) Pub. No.: US 2026/0195233 A1
(43) Pub. Date: Jul. 9, 2026

(54) NATURAL LANGUAGE SECURITY AGENT

(71) Applicant: International Business Machines Corporation, Armonk, NY (US)

(72) Inventors: ODED SOFER, Midreshet Ben Gurion (IL); Yair Allouche, Dvira (IL); Ofer Haim Biller, Neve Boker (IL); Amy Wong, Lexington, MA (US)

(73) Assignee: International Business Machines Corporation, Armonk, NY (US)

(21) Appl. No.: 19/009,544

(22) Filed: Jan. 3, 2025

(51) Int. Cl. G06F 11/34; G06F 16/338

(52) U.S. Cl. CPC G06F 11/3438; G06F 16/338

(57) ABSTRACT

An embodiment executes a process mining technique to extract event data from a target system during a first interaction session across the target system. The embodiment generates a behavior mapping, the behavior mapping defining a relationship between one or more intended actions, and one or more intended outcomes corresponding to the one or more intended actions. The embodiment generates a confidence score for the relationship between the one or more intended actions and the one or more intended outcomes. The embodiment generates a query for additional information related to the one or more intended actions upon a determination that the confidence score is below a predefined confidence score threshold. The embodiment updates the relationship between the one or more intended actions and the one or more intended outcomes based on the response received to the query for additional information.

### BACKGROUND

The present invention relates generally to computer network security monitoring. More particularly, the present invention relates to a method, system, and computer program for automated security monitoring and threat detection including a natural language security agent.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior.

Virtual agents today can be programmed to do a variety of tasks. These may include answering queries and providing assistive actions to users of applications to respond to user inquiries, offer recommendations, and guide users through tasks or processes within an application. Virtual agents may utilize natural language processing (NLP) algorithms to understand user queries, commands, and interactions, and provide seamless communication and interaction within a platform or system. Further, virtual agents may be programmed to assist in workflow optimization by streamlining processes, suggesting improvements, and enhancing operational efficiency. Virtual agents may be programmed with consideration of regulations, policies, and governance standards, offering guidance on ethical considerations, data privacy, and security practices. By programming virtual agents to perform these technical tasks and provide assistive actions to users, systems can leverage AI technology to streamline operations and improve user experiences.

### SUMMARY

The illustrative embodiments provide for a natural language security agent. An embodiment includes executing a process mining technique to extract event data from a target system during a first interaction session across the target system, the event data comprising one or more events corresponding to one or more actions taken across the target system during the first interaction session. The embodiment also includes generating, by computationally correlating the one or more events of the event data to each other, a behavior mapping, the behavior mapping defining a relationship between one or more intended actions, and one or more intended outcomes corresponding to the one or more intended actions. The embodiment also includes generating a confidence score for the relationship between the one or more intended actions and the one or more intended outcomes, the confidence score based on a probability of correctness of the relationship between the one or more intended actions and the one or more intended outcomes. The embodiment also includes generating a query for additional information related to the one or more intended actions upon a determination that the confidence score is below a predefined confidence score threshold. The embodiment also includes updating, by incorporating additional information provided in response to the query for additional information, the relationship between the one or more intended actions and the one or more intended outcomes defined by the behavior mapping. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example network infrastructure in accordance with an illustrative embodiment;

FIG. 3 depicts a block diagram of an example security agent module in accordance with an illustrative embodiment;

FIG. 4 depicts a block diagram of an example processing environment of a security agent module in accordance with an illustrative embodiment;

FIG. 5 depicts a block diagram of an example process for system security monitoring in accordance with an illustrative embodiment; and

FIG. 6 depicts a flowchart of an example process for automated security monitoring, detection, and response initiation in accordance with an illustrative embodiment.

### DETAILED DESCRIPTION

Cybersecurity is a constantly evolving landscape that requires constant innovation to combat emerging challenges, threats, and system vulnerabilities. Further, in today's world, threat actors are increasingly leveraging generative AI, which further heightens the urgency to enact proactive defense measures. In particular, systems and organizations related to data and database security may be especially vulnerable to generative AI based attacks.

Further, analyst turnover amplifies gaps in this issue, resulting in the loss of valuable enterprise knowledge when previously employed security experts no longer contribute the knowledge they have developed over the course of many years working with particular configurations of computing environments, that has enabled them to develop an understanding all the nuances of the relevant components involved. Despite the critical importance of data security, there remains a notable scarcity of comprehensive knowledge and experienced analysts in cybersecurity. The complex nature of database architecture and the sheer volume and speed of data transactions further compound these challenges. Addressing these gaps is crucial for organizations to effectively safeguard their data assets against evolving threats.

Systems and organizations may possess unique features and/or characteristics based on their particular configurations. Accordingly, systems and organizations may use various hardware, software, and network topologies, which may necessitate a nuanced understanding of all components involved to adequately provide comprehensive security monitoring and threat detection. Tailored monitoring strategies may account for these differences, but a lack of adequately trained security analysts who possess an understanding of the particular features and characteristics of these unique system configurations further exposes these systems to security threats and attacks from malicious actors.

Embodiments of the present disclosure leverage LLM technology to automate threat investigation, thereby enhancing efficiency and effectiveness in threat mitigation. Accordingly, LLM technology may be used in part in the development of automated systems that process and analyze vast amounts of textual data, such as security alerts, incident reports, threat intelligence feeds, and historical security data, to extract valuable insights and patterns related to potential security threats and security threat investigation. By leveraging LLM technology, automated systems can automatically ingest, parse, and analyze textual information related to security monitoring, as well as security incidents and threats. Further, an LLM based agent may be configured to understand the context, semantics, and relationships within the text, enabling an automated security agent to identify past analyst behavior in similar situations, key indicators of compromise, suspicious activities, or emerging threats.

Further, embodiments of the present disclosure may leverage LLM technology to analyze event logs produced as a result of process mining. Process mining involves extracting insights from event data to understand the sequence of activities, behaviors, and interactions within a system. Further, LLM technology enables automated systems to process and interpret the textual information contained in event logs, including but not limited to, user actions, system events, and associated outcomes. By leveraging natural language processing capabilities, an LLM agent may be able to extract meaningful patterns, correlations, and anomalies from the event logs, providing a deeper understanding of the processes and activities captured in the data. By applying LLM technology to analyze event logs generated through process mining, an automated security agent can generate valuable insights into analyst and system behavior, process efficiency, and potential security threats, as well as generate reflections based on those insights. Furthermore, embodiments of the present disclosure consider LLM technology to generate contextualized queries, responses, and recommendations based on the analyzed textual data. Embodiments disclosed herein may include automated systems that can interact with security analysts, provide real-time insights into security incidents, suggest investigative actions, recommend response strategies, and/or initiate automatic responsive actions.

Further, embodiments of the present disclosure may leverage LLM technology to understand and/or replicate an analyst's behavior and actions in various scenarios, by capturing and analyzing the analyst's historical interactions and decision-making processes. Accordingly, some embodiments disclosed herein may be configured to learn from the analyst's past actions, responses to queries, and behaviors to predict and replicate their decision-making in similar situations. This capability allows the system to automate and streamline the analyst's workflow, ensuring consistent and effective responses to security incidents. Even further, embodiments of the present disclosure consider leveraging LLM technology to supplement any gaps in system security monitoring knowledge by providing queries for the analyst to respond to. In scenarios where an automated security agent encounters uncertainties or requires additional information to make informed decisions, an LLM based agent can generate contextualized queries that prompt the analyst for clarification, input, or further details. These queries may serve as a mechanism for the system to seek feedback, validate assumptions, and enhance its understanding of the analyst's intentions and thought processes. By leveraging LLM technology to replicate the analyst's behavior and provide queries for clarification, embodiments of the present disclosure enable automated systems to adapt to varying scenarios, improve decision-making processes, and enhance the overall efficiency of security operations.

Currently there is no way to automatically capture and/or replicate the nuanced understanding that a security analyst possesses regarding a particular system. It is contemplated herein that process mining alone may be insufficient to understand an analyst's thought processes and decision-making comprehensively, since process mining may be limited to actions that occur “on-screen” within the system and may not capture off-screen interactions or external influences. For example, process mining typically focuses on tracking and analyzing the sequence of on-screen actions taken by the analyst, such as clicking buttons, entering data, or executing commands within the system, as well as actions executed within the backend of a system. While this data provides valuable insights into the operational aspects of the analyst's activities, it may nevertheless not account for situations where the analyst seeks advice from a colleague or external source and takes actions based on that advice.

In scenarios where an analyst consults a colleague for advice or guidance, process mining may not capture the off-screen interactions, discussions, or decision-making processes that occur outside the system. These external interactions and influences may play a significant role in shaping the analyst's decisions, thought processes, and actions. Without visibility into these off-screen interactions, process mining alone may provide an incomplete digital representation of the factors influencing the analyst's behavior and decision-making. Furthermore, actions taken based on advice from a colleague may not be directly reflected in the on-screen activities captured through process mining. The decision-making process, rationale behind certain actions, and external inputs from colleagues may not be explicitly documented in the system's event logs or process data. As a result, process mining may overlook critical insights into the collaborative nature of decision-making, knowledge sharing, and external influences that impact the analyst's behavior and actions.

To address these limitations, embodiments of the present disclosure consider combining data resultant from process mining with data from additional data sources, such as machine generated queries for additional information, communication logs, collaboration platforms, or knowledge sharing tools, to capture off-screen interactions and external inputs that contribute to the analyst's decision-making. By integrating these data sources and leveraging natural language based analytics techniques, systems and organizations can gain a more holistic understanding of the analyst's behavior, decision-making processes, and interactions, enabling a comprehensive analysis of security operations and incident response strategies.

Further, currently existing automated security agents may be insufficient in providing comprehensive security monitoring and threat mitigation due to being trained on incomplete data sets. In some cases, this incompleteness stems from a lack of transparency into the thought processes and decision-making of an analyst. While automated systems can capture on-screen actions and system events through process mining, these currently existing automated security systems may not account for off-screen actions, external influences, or the reasoning behind certain decisions made by analysts. This limitation hinders the system's ability to fully understand the context, motivations, and nuances that drive the analyst's behavior and decision-making processes.

To address these limitations and supplement the incomplete data sets generated by process mining, LLM technology can be leveraged to fill in the gaps in these data sets with additional information. In some embodiments, by processing communication logs, collaboration platforms, emails, and other textual data sources, LLM technology may be used to capture off-screen actions, external influences, and the rationale behind the analyst's decisions. Further, embodiments of the present disclosure considering utilizing queries generated by an LLM based agent to collect information from an analyst to fill in the gaps in understanding, provide clarification, and gather additional insights. When an LLM agent analyzes data and identifies areas where more information is needed or where there are uncertainties, the agent can generate targeted queries to prompt the analyst for input, feedback, or explanations. These queries serve as a mechanism for the system to engage with the analyst, seek further details, and enhance its understanding of the context, intentions, and decision-making processes behind the analyst's actions.

The queries generated by an LLM may seek clarification on specific actions taken by the analyst, request additional information about a decision made, or prompt the analyst to provide insights into their reasoning or thought processes. By posing targeted questions, the LLM can guide the analyst to provide the necessary context, background, or details that may be missing from the data or analysis. This interactive process allows the system to bridge gaps in knowledge, validate assumptions, and ensure a more comprehensive understanding of the analyst's activities and interactions, which enables the development of an improved automated security agent. Furthermore, the queries generated by an LLM can be tailored to specific scenarios, security incidents, or decision points where additional information is needed. These queries may be presented to the analyst through the system interface, communication channels, or collaboration platforms, enabling a seamless exchange of information and feedback. By engaging the analyst in a dialogue and soliciting their input, the system can refine its analysis, improve decision-making processes, and enhance the accuracy and effectiveness of security monitoring and threat mitigation efforts.

In an embodiment, the LLM agent can ask the analyst a variety of questions to gather further information and insights during case investigations. Some example queries that the agent may pose to the analyst may include, but are not limited to, the following: “Can you explain the reasoning behind selecting this particular approach or strategy?”, “What factors influenced your decision to prioritize this task over others?”, “Could you elaborate on the expected outcomes or goals of implementing this action?”, “Have you encountered a similar scenario before, and if so, how did you address it?”, “What data or evidence supports your choice to proceed in this direction?”, “Are there any constraints or challenges you foresee in executing this plan?”, “How do you anticipate this action will impact the overall investigation process?”, “Have you considered alternative methods or solutions to achieve the desired outcome?”, “Can you provide insights into the potential risks associated with this course of action?”, “What additional information or resources do you believe would be beneficial in this situation?”

In an embodiment, responses from multiple analysts working across the same different systems may be combined and/or integrated by the LLM agent. Accordingly, by integrating responses from multiple analysts working across different systems can significantly enhance the analysis of analyst and system behavior, as well as improve prediction capabilities. By aggregating and analyzing responses from diverse analysts, the system can benefit from a broader perspective and a more comprehensive dataset. This aggregated data enables the system to identify common patterns, trends, and behaviors across different systems, revealing recurring strategies, preferred approaches, and successful practices employed by analysts. Additionally, analyzing responses from various analysts facilitates the detection of anomalies or deviations in behavior, helping to pinpoint irregularities that may require further investigation. By comparing and contrasting responses, the system gains insights into diverse strategies and approaches, leading to a better understanding of individual behaviors and preferences. Moreover, the aggregated responses can enhance predictive modeling by training models more effectively with a diverse dataset, resulting in more accurate forecasts, recommendations, and decision-making support. Integrating responses from analysts working across different systems also enables the system to generate cross-system insights, identifying common challenges, successful strategies, and opportunities for improvement that transcend individual systems. This holistic view promotes knowledge sharing, collaboration, and informed decision-making, ultimately leading to system-wide optimizations and enhanced operational efficiency.

The present disclosure addresses the deficiencies described above by providing a process (as well as a system, method, machine-readable medium, etc.) that develops an automated security agent that leverages a large-language model (“LLM”) together with process mining to generate comprehensive system security monitoring policies and procedures. The illustrative embodiments provide for automated threat detection and resolution. A “security threat” (or simply “threat”) as referred to herein refers to any potential system or network vulnerability that may have the potential to, or already has been, exploited by one or more actors. A “threat actor” (or simply “actor”) refers to any human or non-human entity, or combination thereof, who may, or already has, attempted a cyber-attack against a system or organization.

Embodiments disclosed herein describe the entity designated for security monitoring as a computer system; however, use of this example is not intended to be limiting, but is instead used for descriptive purposes only. Instead, the entity designated for security monitoring can include elements of or more of a network environment, an organization, a physical location, a software application, as well as a component of a system, as well as any sub-component of any component, as well as any combination thereof.

Further, although in some embodiments an LLM is described, use of this example is not intended to be limiting, but is instead used for descriptive purposes only. Instead, the one or more machine learning algorithms or neural network architectures may include aspects of any other known or to be discovered algorithms or neural network architectures suitable to accomplish the operations disclosed herein.

The following description provides examples of embodiments of the present disclosure, and variations and substitutions may be made in other embodiments. Several examples will now be provided to further clarify various aspects of the present disclosure.

Example 1: A computer-implemented method that comprises executing a process mining technique to extract event data from a target system during a first interaction session across the target system, such that the event data comprises one or more events corresponding to one or more actions taken across the target system during the first interaction session. The method further comprises generating, by computationally correlating the one or more events of the event data to each other, a behavior mapping, such that the behavior mapping defines a relationship between one or more intended actions, and one or more intended outcomes corresponding to the one or more intended actions. The method further comprises generating a confidence score for the relationship between the one or more intended actions and the one or more intended outcomes, such that the confidence score is based on a probability of correctness of the relationship between the one or more intended actions and the one or more intended outcomes. The method further comprises generating a query for additional information related to the one or more intended actions upon a determination that the confidence score is below a predefined confidence score threshold. The method further comprises updating, by incorporating additional information provided in response to the query for additional information, the relationship between the one or more intended actions and the one or more intended outcomes defined by the behavior mapping.

The above limitations advantageously enable the ability to provide a detailed understanding of the interactions within the target system. By extracting event data and correlating the events to each other computationally, a behavior mapping is generated. This behavior mapping defines the relationship between intended actions and outcomes, providing insights into the system's behavior. Another advantage of this method includes the quantification of the relationship between intended actions and outcomes through the confidence score. This allows for a more objective assessment of the correctness of the relationship, enabling more accurate automated decision-making based on the generated behavior mapping. Another advantage of this method is provided by generating a query for additional information related to the intended actions when the confidence score falls below a predefined threshold. This feature allows for the identification of uncertainties in the relationship between intended actions and outcomes. An advantage of this feature includes the ability to proactively seek additional information to improve the accuracy of the behavior mapping. By generating a query for more information when the confidence score is below the predefined threshold, the method ensures that the relationship between intended actions and outcomes is continuously refined and updated. Another advantage of this method is provided by updating the relationship between intended actions and outcomes by incorporating the additional information obtained in response to the query, which enhances the accuracy and reliability of the behavior mapping by integrating new insights into the relationship. Another advantage of this feature is the iterative improvement of the behavior mapping based on the feedback obtained from the additional information. By updating the relationship between intended actions and outcomes, the method adapts to new data and insights, leading to a more precise understanding of the system's behavior and enhancing decision-making capabilities.

Example 2: The limitations of Example 1, where the method further comprises monitoring the target system during a second interaction session to detect a similar activity detected during the first interaction session. The method further comprises generating, upon detection of the similar activity, a recommendation based on the similar activity detected.

The above limitations advantageously enable identifying recurring patterns or behaviors within the system. An advantage of this feature is the ability to recognize and track repeated activities or patterns across different interaction sessions. By detecting similar activities during the second interaction session, the method can establish consistency in behavior and identify common trends within the system. The above limitations also advantageously enable generating a recommendation based on the similar activity detected during the second interaction session. This recommendation leverages the identified patterns to provide guidance or suggestions for future actions or decisions. Another advantage of this feature is the proactive nature of the recommendations generated based on detected similar activities. By analyzing the recurring patterns and behaviors, the method can offer tailored recommendations to optimize processes, improve efficiency, or prevent potential issues based on past experiences.

Example 3: The limitations of Example 2, where the method further comprises automatically initiating a responsive action within the target system upon acceptance of the recommendation generated based on the similar activity detected.

The above limitations advantageously enable automation of responsive actions based on accepted recommendations. By automatically triggering actions within the system, the method streamlines the implementation of suggested improvements or optimizations, reducing manual intervention and enhancing operational efficiency. This feature ensures that the accepted recommendation leads to a prompt and accurate response within the target system. Also, this immediate responsiveness to accepted recommendations minimizes delays in implementing beneficial changes identified through the analysis of similar activities. Another advantage provided by this feature includes the real-time execution of responsive actions, which allows the system to adapt quickly to insights gained from the detected similar activities. By promptly acting on accepted recommendations, the method facilitates continuous improvement and optimization of system behavior based on identified patterns and best practices.

Example 4: The limitations of Example 1, where the method further comprises monitoring the target system during a second interaction session to detect a similar activity to an activity detected during the first interaction session, analyzing the similar activity to detect a deviation between event data corresponding to the first interaction session and event data corresponding to the second interaction session, generating a second query for additional information related to the one or more intended actions upon a detection of the deviation between event data corresponding to the first interaction session and event data corresponding to the second interaction session, and updating, by incorporating the additional information provided in response to the second query for additional information, the relationship between the one or more intended actions and the one or more intended outcomes defined by the behavior mapping.

The above limitations advantageously enable the ability to track and compare activities across multiple interaction sessions, enabling the method to identify deviations or changes in behavior over time. By analyzing similarities and differences between event data from different sessions, the method can detect anomalies or variations that may require further investigation. In some cases, the computer-implemented method involves generating a second query for additional information related to the intended actions upon detecting a deviation between event data from the first and second interaction sessions. This query seeks to gather more insights into the reasons behind the observed deviations, enhancing the understanding of the system's behavior. Another advantage of this feature is the proactive approach to investigating deviations between interaction sessions. By generating a second query for additional information, the method prompts a deeper analysis of the discrepancies, leading to a more comprehensive understanding of the factors influencing changes in behavior within the system. The method also includes updating the relationship between intended actions and outcomes by incorporating the additional information obtained in response to the second query for additional information. This update process ensures that the behavior mapping reflects the most current and accurate understanding of the system's behavior. By integrating new insights into the behavior mapping, the method adapts to changes in the system and improves the accuracy of decision-making processes.

Example 5: The limitations of Example 1, where the event data extracted from the target system during the first interaction session across the target system is processed by a large-language model to computationally predict the one or more intended actions and the one or more intended outcomes.

The above limitations advantageously enable increased prediction accuracy of intended actions and outcomes based on the event data. By leveraging the capabilities of a large language model, the method can extract nuanced insights from the data, leading to more precise predictions and behavior mappings. Also, the method benefits from the scalability and efficiency of processing event data through a large-language model designed to handle vast amounts of data and complex patterns, allowing for comprehensive analysis and prediction of intended actions and outcomes across the target system. Another advantage of this feature is the ability to scale the computational prediction process to handle large datasets and diverse interactions within the target system. By utilizing a large-language model, the method can effectively process and analyze event data from various sources, enabling a more comprehensive understanding of the system's behavior.

Example 6: The limitations of Example 1, where the query for additional information is displayed via a user interface as a natural language query, and the additional information provided in response to the query for additional information is input via the user interface.

The above limitations advantageously enable users to interact with the system using human-readable language. This user-friendly approach simplifies the process of seeking additional information related to intended actions and outcomes within the system. An advantage of this feature is the enhanced user experience provided by the natural language query interface. By presenting queries in a format that is easily understandable to users, the method promotes user engagement and facilitates efficient communication between the system and the users. This method also enables users to input the additional information provided in response to the query for additional information via the user interface. This input method allows users to contribute insights, feedback, or clarifications directly through the interface, fostering collaboration and knowledge sharing within the system. Another advantage of this feature is the seamless integration of user input into the system's decision-making processes. By enabling users to provide additional information via the user interface, the method incorporates diverse perspectives and domain knowledge, enriching the analysis and refinement of the relationship between intended actions and outcomes.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

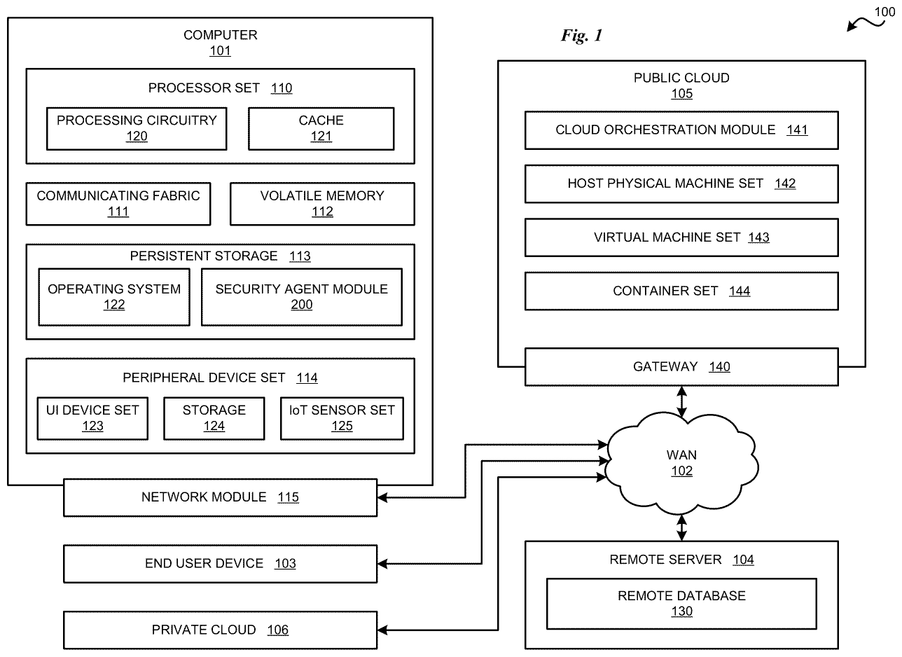

FIG. 1 depicts a block diagram of a computing environment 100. Computing environment 100 contains an example of an environment for the execution of at least some of the computer code involved in performing the inventive methods, such as security agent module 200 that provides for automated threat detection and resolution, based at least in part on on capturing and analyzing a user's behavior across a system. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

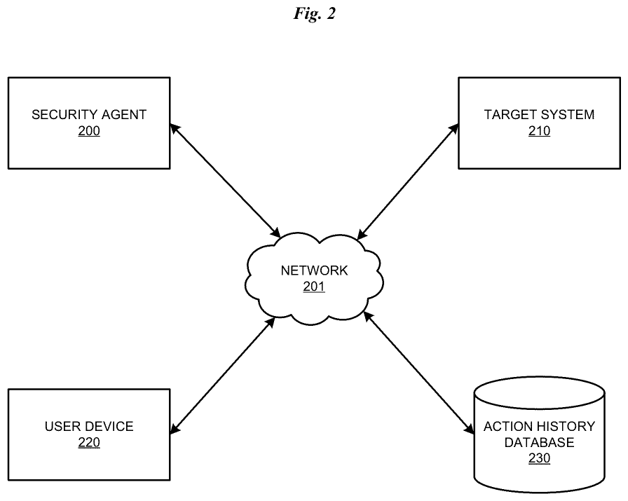

FIG. 2 depicts a block diagram of an example network infrastructure in accordance with an illustrative embodiment. In the illustrated embodiment, the security agent module 200 includes security agent module 200 of FIG. 1.

In the illustrated embodiment, security agent module 200 is configured to perform various operations, as described in greater detail herein. In an embodiment, the security agent module 200 is configured to establish a connection to target system 210 via any suitable network 201 to perform the following example operations. In an embodiment, upon establishing a connection with target system 210, the security agent module 200 executes a process mining program in order to extract one or more events that occur during interaction across a digital channel of target system 210. In an embodiment, execution of the process mining program yields one or more events, a combination of events collectively defines an action, and a sequence of actions collectively defines an activity.

In the illustrated embodiment, the security agent module 200 includes a process mining component configured to extract and/or analyze events that occur during an interaction session within a digital channel. In an embodiment, the process mining component of security agent module 200 collects and analyzes event data generated during interactions with the target system 210. In an embodiment, process mining includes utilizing one or more algorithms and/or machine learning models to extract valuable insights from event logs, such as, for example, the sequence of actions taken, timestamps, and outcomes. By mapping out the processes followed by the security analyst, the process mining component enables the security agent module 200 to identify patterns of behavior across the target system 210.

In an embodiment, the process mining component employs one or more natural language processing techniques to extract and/or analyze events from an event log generated by the digital channel. In an embodiment, the process mining component is configured to identify patterns, trends, and/or deviations in the sequence of events to provide insights into the behavior of a system and/or a user and/or agent interacting with the system.

In the illustrated embodiment, the security agent module 200 includes a natural language processing (“NLP”) component. In an embodiment, the NLP component employs a large language model (“LLM”) configured to understand the correlations between the events obtained through process mining. In an embodiment, the NLP component may employ one or more natural language processing techniques and deep learning algorithms to comprehend the context and meaning of the events. Accordingly, by leveraging a large language model, security agent module 200 can interpret the relationships between different events, develop insight regarding past actions taken across the target system 210, identify potential security threats, and make informed decisions based on the analyzed data.

In an embodiment, the security agent module 200 may be configured to perform a comprehensive analysis of the target system 210 and user interactions across the target system 210 to understand the underlying dynamics of the system, behavior of a user interacting with the system, and/or sequences of events and taken place over a system, as well as their associated outcomes. Accordingly, by leveraging the one or more natural language processing techniques and deep learning algorithms to process textual data extracted from event logs, the security agent module 200 is able to decipher the sequence of events and user intentions within the target system 210 and uncover the context, relationships, intentions, and implications of user actions in the digital environment.

In an embodiment, the security agent module 200 may be configured to determine and evaluate a user's objectives and intentions within the target system 210. By analyzing the user's interactions and behaviors, the security agent module 200 is configured to identify the user's goals, preferences, and motivations behind their actions. In some embodiments, analyzing user interactions may include, but is not limited to, interpreting the user's input, commands, and queries to generate predictions regarding the purpose and desired outcomes of their interactions with the target system 210.

In an embodiment, the security agent module 200 may be configured to evaluate the intended or expected results of a user's actions compared to the actual outcomes observed in the target system 210. Accordingly, by analyzing discrepancies between the intended and realized outcomes, the security agent module 200 is able to identify potential issues, errors, and/or inefficiencies in the target system's functionality. This analysis enables the security agent module 200 to provide insights into the effectiveness of the user's actions and suggest recommendations and/or improvements to enhance the user experience and achieve desired results.

In an embodiment, the security agent module 200 may be configured to explore potential actions that could be taken to optimize the user's ability to achieve their desired outcomes. By considering alternative strategies, recommendations, and interventions, the security agent module 200 enhances the user's decision-making process, streamline workflows, and increase the likelihood of successful outcomes. This proactive approach allows the security agent module 200 to assist users in navigating the system more effectively and achieving their objectives with greater efficiency.

In an embodiment, the events generated during the interaction are input to and processed by an LLM based agent to generate insights into the actions taken by the analyst interacting with target system 210 and the reasons behind those actions. In an embodiment, the security agent module 200 may be configured to generate one or more queries to the analyst to clarify intentions and/or provide greater context details to be able to be able to better provide recommendations for achieving desired outcomes within the system.

In an embodiment, the automated security agent includes a policy generation component. In an embodiment, the policy generation component utilizes the insights provided by the LLM and processing mining components to create comprehensive system security monitoring policies and procedures. These policies are designed to enhance the security posture of the system by defining rules, alerts, and responses to various security events. By automating the policy generation process, the security agent module 210 can adapt quickly to new threats and changes in the system environment to provide robust security measures at all times in real-time.

In an embodiment, the automated security agent includes a recommendation engine component. In an embodiment, the recommendation engine component may collaborate with the LLM to provide tailored recommendations to the security analyst. By analyzing the analyst's behavior and intentions, as well as the insights gathered from process mining, the recommendation engine can suggest optimal courses of action to achieve the desired security outcomes.

In the illustrated embodiment, security agent module 200 is communicatively coupled to action history database 230. In an embodiment, action history database 230 is configured to store all action history data and context data related to actions obtained during process mining, through queries, and/or user input data. Accordingly, the action history database 230 is designed to capture a comprehensive record of all interactions and events within the target system 210, thereby providing a comprehensive source of information for analysis and decision-making processes. In an embodiment, the action history database 230 stores detailed information about each action taken within the target system 210, including the type of action, timestamp, user ID, and any associated metadata. This data allows the security agent module 200 to track the sequence of events, identify patterns, and detect anomalies that may indicate potential security threats or vulnerabilities.

In an embodiment, in addition to storing action history data, the action history database 230 also captures context data surrounding each action. This context data includes information about the system state, environmental variables, user roles, and any other relevant factors that may influence the outcome of the action. By recording this contextual information, the database allows the security agent module 200 to analyze actions with respect to their context and make informed decisions based on a holistic view of the system. In an embodiment, the security agent module 200 is configured to integrate data obtained from process mining, queries, and user input sources. By consolidating data from multiple channels, the database provides a unified view of an analyst's and/or system's behavior and the interactions between different components of the target system 210. This integrated approach enhances the accuracy and reliability of the data stored in the database, enabling the automated security agent to generate more precise insights, reflections, and recommendations for improving system security. Accordingly, action history database 230 maintains a comprehensive and structured repository of action history data and context data within the system.

In the illustrated embodiment, security agent module 200 is also in communication with network 201. Network 201 includes a plurality of network data sources. Network data sources can include any known types of network monitoring systems or sensors that generate network monitoring data. The exact devices used to generate network monitoring data may be implementation-specific and dependent upon the type of network.

In the illustrated embodiment, user device 220 allows a user with sufficient privileges to perform various tasks associated with security agent module 300. In some embodiments, user device 210 allows a user with administrative privileges to perform various administrative tasks associated with security agent module 300, as described in greater detail herein. User device may include any type of computing device, including but not limited to, a desktop computer, a laptop, a smartphone, a tablet, a wearable device, and/or any combination thereof.

In an embodiment, a service infrastructure provides services and service instances to a user device 220. In an embodiment, user device 220 communicates with the service infrastructure via an API gateway. In various embodiments, the service infrastructure and its associated security agent module 200 serve multiple users and multiple tenants. A tenant is a group of users (e.g., a company) who share a common access with specific privileges to the software instance. In some embodiments, the service infrastructure ensures that tenant specific data is isolated from other tenants. In some embodiments, user device 220 connects with an API gateway via any suitable network or combination of networks such as the Internet, etc. and uses any suitable communication protocols such as Wi-Fi, Bluetooth, etc. Service infrastructure may be built on the basis of cloud computing. In an embodiment, the API gateway provides access to client applications like security agent module 200. In some embodiments, the API gateway receives service requests issued by client applications and creates service lookup requests based on service requests. As a non-limiting example, in an embodiment, user device 220 executes a routine to initiate interaction with security agent module 200. For instance, in some embodiments, user device 220 executes a routine to instruct security agent module 200 to monitor target system 210 according to embodiments described herein.

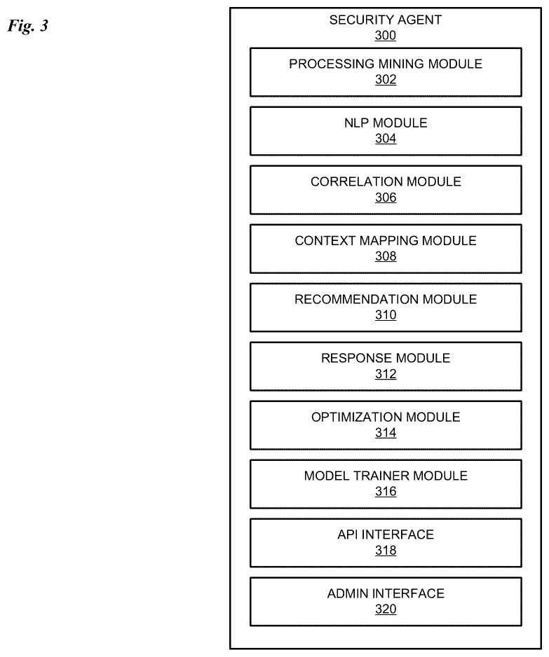

FIG. 3 depicts a block diagram of an example security agent module in accordance with an illustrative embodiment. In an embodiment, security agent module 300 includes security agent module 200 of FIG. 1 and FIG. 2. In the illustrated embodiment, security agent module 300 includes a processing mining module 302, an NLP module 304, a correlation module 306, a context mapping module 308, a recommendation module 310, a response module 312, an optimization module 314, a model trainer module 316, an API interface module 318, and an admin interface module 320. In alternative embodiments, security agent module 300 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, process mining module 302 is configured for collecting and analyzing event data generated within a target system. In an embodiment, processing mining module 302 utilizes one or more known algorithms and techniques to extract insights from the event logs, such as the sequence of actions, timestamps, and outcomes. Further, by mapping out the processes followed by a security analyst, the process mining module 302 enables the security agent module 300 to identify behavior patterns, anomalies, as well as potential security risks within the system.

In the illustrated embodiment, the security agent module 300 includes a natural language processing (“NLP”) Module 304. In an embodiment, the NLP Module 304 is designed to understand and interpret human language input. In an embodiment, the NLP module is configured to process text data to extract meaning, identify patterns, and derive insights from the information provided. Further, by leveraging NLP techniques such as sentiment analysis and entity recognition, the NLP module 304 enhances the security agent's ability to comprehend analyst actions, queries, responses to queries, user input, and other textual data within the system.

In the illustrated embodiment, the security agent module 300 includes a correlation module 306. In an embodiment, the correlation module 306 is configured to identify relationships and dependencies between different data points within the system. In an embodiment, the correlation module 306 analyzes the data collected from various sources described herein to detect patterns, trends, and anomalies that may be relevant to an analysts behavior in responding to potential security threats. By correlating potentially disparate pieces of information, the correlation module 306 may help the security agent module 300 uncover hidden connections and help make informed decisions to mitigate security risks effectively.

In the illustrated embodiment, the security agent module 300 includes a context mapping module 308. In an embodiment, the context mapping module 308 is designed to capture and organize contextual information surrounding actions and events within the system. For example, the context mapping module 308 may store data related to the system state, user roles, environmental variables, and other relevant factors that influence the security posture of the system. By mapping out the context in which actions occur, the context mapping module 308 enables the security agent module 300 to make informed decisions based on a holistic understanding of the system's environment.

In the illustrated embodiment, the security agent module 300 includes a recommendation module 310. In an embodiment, the recommendation module 310 leverages insights from the process mining module 302, NLP Module 304, correlation module 306, and context mapping module 308 to provide tailored recommendations to a security analyst. By analyzing data and patterns within the system, the recommendation module 310 suggests optimal courses of action to enhance security monitoring, mitigate risks, and improve overall system security.

In the illustrated embodiment, the components of security agent module 300 communicate and interact with each other in a cohesive and collaborative manner to enhance the overall security monitoring and decision-making processes. In an embodiment, event data collected by the process mining module 302 is passed on to the NLP Module 304, which interprets textual information, along with responses to queries and user input, to extract meaningful insights. In an embodiment, the correlation module 306 analyzes data from various sources, including the outputs of the process mining module 302 and NLP Module 304, to identify patterns and relationships that may indicate analyst behavior related to security threat monitoring. Further, the insights generated by the correlation nodule 306 may be integrated with the contextual information captured by the context mapping module 308.

Further, in an embodiment, the correlation module 306 is also designed to interpret and understand a security analyst's operations and intentions to respond to potential security threats. By examining the actions taken by the analyst, as captured by the process mining module 302, and interpreting the textual information processed by the NLP Module 304, the correlation module 306 can gain insights into the analyst's decision-making processes and response strategies. This analysis helps the security agent module 300 understand the analyst's behavior patterns, preferences, and priorities when addressing security threats.

Even further, in an embodiment, the correlation module 306 is configured to identify correlations between the analyst's actions and the potential security threats detected within the system. By correlating the analyst's responses to specific security incidents with the corresponding threat indicators, the module can establish relationships that help predict the analyst's future actions in similar scenarios. This predictive capability enables the security agent module 300 to automate and replicate the analyst's responses when similar security threats are identified in the future, streamlining the incident response process and enhancing the system's overall security posture. Accordingly, the correlation module 306 facilitates the analysis of data from various sources to detect security threats, understand the analyst's operations and intentions, and automate response strategies based on historical patterns and correlations.

In the illustrated embodiment, the context mapping module 308 organizes and stores contextual data related to system states, user roles, and environmental variables. This contextual information enriches the analysis performed by the other modules and provides a comprehensive view of the system's security landscape. In some embodiments, the context mapping module 308 ensures that actions and events are evaluated with respect to their context, which allows the security agent module 300 to make informed decisions based on a holistic understanding of the system environment.

In the illustrated embodiment, the recommendation module 310 utilizes the insights gathered from the process mining module 302, NLP Module 304, correlation module 306, and context mapping module 308 to generate tailored recommendations for the security analyst. These recommendations may be designed to optimize security monitoring, mitigate risks, and/or improve overall system security. By leveraging the collective intelligence of all components, the security agent module 300 can proactively address security challenges and enhance the effectiveness of security policies and procedures within the system. Further, in an embodiment, the recommendation module 310 considers historical data to provide tailored recommendations to the security analyst based on insights gathered from various components, including the actions and response strategies taken by previous analysts in similar scenarios in the past. By considering historical data and past experiences, the recommendation module 310 can offer guidance to a current analyst when responding to security threats. By examining historical patterns and outcomes, the module can identify effective approaches and best practices that have been successful in mitigating security threats in the past.

Further, in an embodiment, the recommendation module 310 utilizes one or machine learning algorithms and/or predictive analytics techniques to identify trends and correlations between past actions and their outcomes. By analyzing the historical data of previous analysts'responses to security incidents, the module can generate recommendations that are tailored to the specific context of the current security threat. These recommendations may be designed to optimize the analyst's decision-making process and increase the likelihood of a successful response to the security incident.

In the illustrated embodiment, the response module 312 is configured to initiate a responsive action. In an embodiment, the response module 312 is configured to initiate a responsive action upon acceptance of a recommendation generated by recommendation module 310. In an embodiment, the response module 312 is designed to translate the recommended actions generated by recommendation module 310 into executable responses within the system, enabling the security agent module 300 to automatically proactively address security threats based on the guidance provided by the recommendation module 310. When a recommendation is generated by the recommendation module 310 and accepted by the security analyst, the response module 312 receives the approved course of action. The response module 312 then translates this recommendation into specific response strategies that align with the analyst's decision. This translation process involves converting the recommended actions into operational commands that can be executed within the system to mitigate the identified security threat effectively.

In an embodiment, the response module 312 is configured to interact with the system's security controls, protocols, and response mechanisms to implement one or more recommended actions. In some embodiments, the response module 312 may trigger automated responses, adjust security settings, initiate threat containment measures, or communicate alerts to relevant stakeholders based on the accepted recommendation. Further, in some embodiments, the response module 312 may incorporate feedback loops to monitor the outcomes of the initiated responsive actions. By tracking the effectiveness of the implemented strategies and analyzing the results in real-time, the module can provide continuous feedback to the recommendation module 310. This feedback loop enables the system to learn from past responses, refine its recommendations, and improve the overall incident response capabilities over time.

In the illustrated embodiment, the optimization module 314 is configured to optimize incident response strategies and security monitoring protocols based on one or more machine learning models output by the model trainer module 316. Accordingly, the optimization module 314 leverages one or more machine learning models trained by the model trainer module 316 to enhance the efficiency and effectiveness of incident response and security monitoring within the system. In the illustrated embodiment, the model trainer module 316 is configured for training machine learning models on historical data, patterns, and outcomes of security incidents. Accordingly, these models learn from past experiences and data to identify trends, correlations, and predictive patterns that can be used to improve incident response strategies and security monitoring protocols. Once the machine learning models are trained, they may utilized to provide insights and recommendations that can be utilized by the optimization module 314.

In an embodiment, the optimization module 314 receives the output of one or more machine learning models from the model trainer module 314. These models may include one or more aspects of predictive models, anomaly detection models, classification models, or clustering models that provide insights into security monitoring behavior, security threats, incident trends, and effective response strategies. By leveraging the outputs of these machine learning models, the optimization module 314 can optimize incident response strategies and security monitoring protocols in real-time. Further, based on the recommendations and insights provided by the machine learning models, the optimization module 314 may adjust incident response plans, and security monitoring protocols, and fine-tune response strategies to better align with the current threat landscape and unique configuration of the system. The module may dynamically update response playbooks, adjust alert thresholds, optimize resource allocation, or enhance incident prioritization based on the continuous analysis of incoming data and model outputs.

In an embodiment, the model trainer module 316 is configured for training a large language model (“LLM”) to understand analyst actions based on events generated by the process mining module 302 during analyst interaction with a target system. Accordingly, the LLM may be trained to interpret and analyze the actions taken by analysts within the system, leveraging event data collected during the interaction to gain insights into the behavior and decision-making processes of the analysts. In an embodiment, the model trainer module 316 utilizes the event data generated by the process mining module 302, such as the sequence of actions, timestamps, and outcomes of analyst interactions with the system. This event data may serve as the training dataset for the LLM, providing a domain-specific source of information for the model to learn from. By analyzing the patterns and trends within the event data, the model can identify common actions, decision points, and response strategies employed by analysts in various scenarios.

In an embodiment, the model trainer module 316 trains the LLM using natural language processing (NLP) techniques to understand and interpret the textual and contextual information associated with analyst actions. By processing the event data and textual inputs, the model learns to recognize patterns, extract meaningful insights, and predict potential actions based on the historical data. Through the training process, the model becomes proficient in understanding the intentions, behaviors, and decision-making processes of analysts interacting with the system.

Further, in an embodiment, the model trainer module 316 fine-tunes the LLM to adapt to the specific context and nuances of the security domain. By incorporating domain-specific knowledge and terminology, the model can better understand security-related actions, responses, and alerts within the system. This domain-specific training enhances the model's ability to accurately interpret and analyze analyst actions in the context of security incidents and threats.

In the illustrated embodiment, model training module 316 includes a model trainer component. In some embodiments, model trainer 316 includes a data preparation module, algorithm module, training engine, and machine learning model. In alternative embodiments, model training module 316 can include some or all of the functionality described herein but grouped differently into one or more modules. In some embodiments, model trainer module 316 generates a machine learning model based on an algorithm provided by algorithm module. In an embodiment, algorithm module selects the algorithm based on one or more known machine learning algorithms. In an embodiment, model trainer 316 includes a training engine that trains a machine learning model using a training dataset. In some embodiments, training dataset includes historical analyst activity data for training an LLM to predict the next action of analyst and/or sequential series of actions of an analyst.

In some embodiments, the training dataset is pre-processed by a data preparation module for the model trainer. In some such embodiments, data preparation module structures the data to make best use of machine learning model. In an embodiment, the training engine trains machine learning model using training dataset, resulting in trained machine learning model. In some embodiments, training dataset is divided into two discrete subsets, where one subset is used by training engine for initially training machine learning model. The other subset is used by the training engine to test the trained model and determine the accuracy of the trained model.

In the illustrated embodiment, an API interface 318 allows security agent module 300 to interact with and transmit data and executable commands between various applications. In some embodiments, the API interface 318 establishes a connection with various security related tools, and causes said security related tools to execute specific actions and processes, as described in greater detail herein.

In the illustrated embodiment, an administrative interface device 320 allows users with administrative privileges to perform various administrative tasks associated with security agent module 300 as described herein. For example, in some embodiments, administrative interface 320 allows an administrative user to initiate a data collection process or system monitoring process. As another example, in some embodiments, administrative interface 318 allows a user with administrative privileges to initiate and monitor the training process performed by model training module 316, including setting desired hyperparameters for the training process.

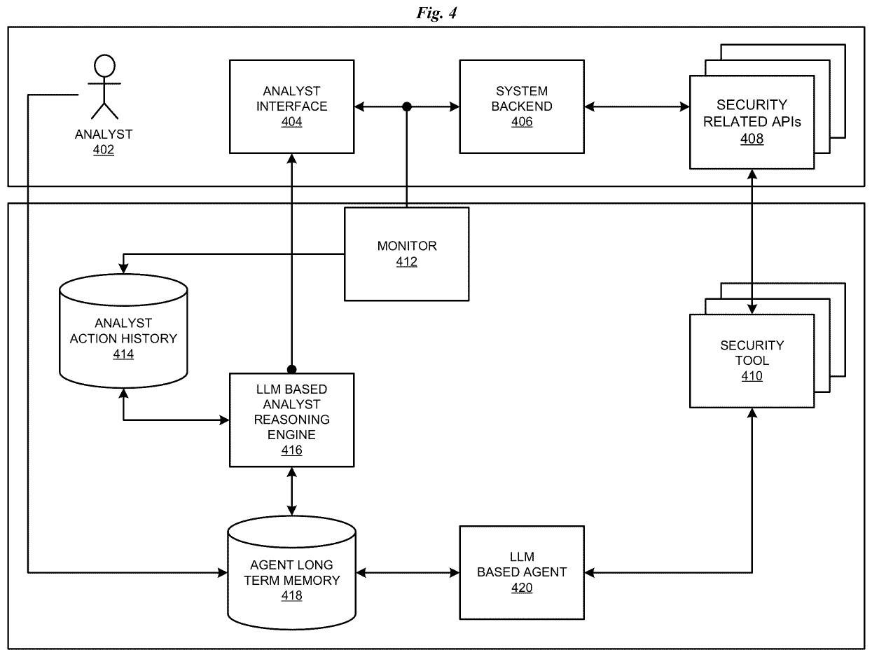

FIG. 4 depicts a block diagram of an example processing environment of a security agent module in accordance with an illustrative embodiment. In the illustrated embodiment, the security agent module 200 of FIGS. 1 and 2 and/or security agent module 300 of FIG. 3 is configured to carry out operations depicted by FIG. 4.

In the illustrated embodiment, analyst interface module 404 enables an analyst 402 to interface with a system backend 404 of a target system. In the illustrated embodiment, the analyst interface module 404 facilitates the interaction between an analyst 402 and the system backend 406 of a target system. Accordingly, the analyst interface module 404 serves as an interface through which the analyst can access, monitor, and interact with the backend components of the target system to perform security-related tasks and activities. Further, the analyst interface module 404 allows the analyst 402 to access and navigate the functionalities of the system backend 406, and allows the analyst 402 to observe system status, security alerts, logs, and other relevant information necessary for monitoring and managing security incidents. In some embodiments, the module presents the information in a structured and intuitive manner, enabling the analyst 402 to easily interpret and respond to security events.

Further, in an embodiment, the analyst interface module 404 allows the analyst 402 to interact with the system backend 406 to perform various security-related actions. These various security-related actions may include, but are not limited to, initiating security scans, configuring security settings, responding to alerts, investigating security incidents, and executing response strategies. In an embodiment, the analyst interface module 404 provides tools and functionalities for the analyst 402 to actively engage with the system backend 404 and carry out security related tasks. Even further, in some embodiments, the analyst interface module 404 may incorporate features such as dashboards, visualizations, and reporting tools to present security-related data in a comprehensible format. The module may also offer interactive elements, such as filters, search functions, and customizable views, to enhance the analyst's ability to navigate and analyze security information efficiently.

In the illustrated embodiment, the security related APIs 408 connect to various security tools 410. Accordingly, the security related APIs 408 serve as the interface through which security tools can exchange data, trigger actions, and collaborate to enhance the overall security posture of the system. Examples of security tools 410 may include, but, are not limited to the following: Vulnerability scanners, which identify weaknesses and vulnerabilities in the system's infrastructure, applications, and network devices. Additionally, APIs can integrate with intrusion detection systems (IDS) that monitor network traffic and systems for suspicious activities or potential security breaches. Security Information and Event Management (SIEM) systems can also be connected through APIs to aggregate, correlate, and analyze security event data from various sources within the system, providing real-time monitoring, threat detection, and incident response capabilities. Even further, endpoint protection platforms, firewalls, web application firewalls (WAF), identity and access management (IAM) systems, and other security tools can also be linked via security-related APIs to create a comprehensive security ecosystem.

In the illustrated embodiment, the activity monitor 412 monitors the analyst's interactions between the analyst interface 404 and the system backend 406 using one or more known process mining techniques. Process mining may include collecting event data and analyzing event data to extract insights, patterns, and trends related to the sequence of actions taken during a security monitoring process. Accordingly, the activity monitor 412 may employ a process mining technique to track and analyze the flow of activities performed by the analyst 402 within the system, providing visibility into their interactions and behaviors.

Further, through process mining, the activity monitor 412 captures various types of events that occur during the analyst's interactions with the system. These events may include, but are not limited to, login and logout events, navigation events that track the analyst's paths within the system, action events recording specific actions performed, alert events monitoring the handling of security alerts, permission events tracking changes in access levels, error events capturing anomalies, and workflow events monitoring the progression of security workflows. Further, in an embodiment, the activity monitor 412 includes monitoring all analyst investigation and response actions, capturing relevant context such as alerts/cases, visible data, and data retrieved through analyst actions. By capturing these events, the activity monitor 412 gains insights into the analyst's behavior, decision-making processes, and system interactions. In the illustrated embodiment, events captured by the activity monitor 406 are stored on analyst action history database 414.

In an embodiment, the activity monitor 412 leverages reasoning capability of a trained LLM based reasoning engine 414 to reason about the actions of security analysts during threat investigation and hunting processes. In an embodiment, the LLM based reasoning engine 414 receives raw or processed investigation data, along with the corresponding actions undertaken by security analyst, and the LLM is then tasked with reasoning about these actions. In some embodiments, the result of this LLM based reasoning is expressed as “reflections” which may include transition rules between the investigation state and the actions, formulated in natural language. Accordingly, this natural language formalization may offers a rich, generalized, and flexible representation of states and actions. In the illustrated embodiment, the reflections are stored in LLM agent's long term memory 418. Further, in the illustrated embodiment, the security analyst 402 may insert reflections directly to agent long term memory 418, allowing the analyst 402 to inject domain knowledge into the system. Further, it is contemplated herein that reflections may comprise more than single transition rules, and in some embodiments they form a flow-graph of states and actions. For example, in cases of Category Schema-Tampering, the module may check the user's group and escalate the alert if the user is in the ADMIN group and the commands associated with them include DDL commands. Further, stored reflections may be retrievable and shared within the organization and cross-organizations, thereby providing an effective means of distribution of best practices among analysts.

Further, in an embodiment, during the reasoning process, the LLM component may be tasked to associate a given threat with various hypotheses about the given threat (e.g., the threat actor has used stolen credentials to access the DB), recommend investigation actions (e.g., find when these credentials where generated and last used), or propose specific actions to be taken (e.g., revoking these credential). Additionally, the module can aggregate similar threats and analyze commonalities and differences between them to better understand the rationale behind analyst actions. For instance, the LLM based reasoning engine 416 may recognize that in cases of suspicious database activity, analysts revoke user access when sensitive data is involved but close the case with a comment if the data is non-sensitive.

In the illustrated embodiment, LLM-based analyst reasoning engine 416 analyzes analyst actions stored in the analyst action database 414 to generate queries to the analyst, which are then displayed via the analyst interface 404. In an embodiment, the analyst reasoning engine 416 leverages an LLM to interpret and understand the actions taken by the analyst 402 within the system, stored in the Analyst Action Database 414. Further, upon analyzing this historical data, the analyst reasoning engine 416 generates one or more queries that prompt the analyst for further information regarding their decision-making processes and actions.

The LLM-based Analyst Reasoning Engine 416 utilizes natural language processing (NLP) techniques to analyze the textual and contextual information associated with the analyst's actions stored in the Analyst Action Database 414. By processing this data, the engine can identify patterns, trends, and anomalies in the analyst's behavior, enabling it to generate queries that seek clarification or additional information from the analyst. These queries may be designed to elicit insights into the rationale behind the analyst's decisions, the thought process followed, and the context surrounding specific actions taken within the system. The queries may include requests for further details, explanations, or justifications regarding specific actions or decisions made by the analyst. By engaging the analyst in a dialogue and soliciting additional information, the analyst reasoning engine 416 is designed to enhance its understanding of the analyst's thought processes, preferences, and intentions, which provides a more comprehensive insight into the analyst's actions and interactions with the target system.

In the illustrated embodiment, insights generated from the LLM-based analyst reasoning engine 416 are stored in the agent long-term memory 418 to allow an LLM-based security agent 420 to automatically interact with and deploy security tools 410. The agent long-term memory 418 serves as a repository for storing reflections, insights, patterns, and knowledge derived from the analysis of analyst actions and interactions by the analyst reasoning engine 416. These insights are stored in the long-term memory to build a knowledge base that can be leveraged by the security agent 420 for automated decision-making and interaction with security tools 410.

In some embodiments, the insights stored in the agent long-term memory 418 may include information about the analyst's behavior, decision-making processes, response strategies, and interactions with the system. By capturing and retaining these insights, the long-term memory enables the security agent 420 to develop a comprehensive understanding of the analyst's actions and preferences over time. Further, by leveraging the knowledge stored in the long-term memory, the Security Agent 420 can automatically execute or more security actions and/or deploy appropriate security measures in response to detected threats or anomalies. Accordingly, the agent can proactively engage with security tools, trigger automated responses, adjust security configurations, and execute predefined security protocols based on the insights derived from the analyst reasoning engine 416.

Further, in the illustrated embodiment, the security tools 410 may serve as a bridge between the security agent 420 and various and security products. In an embodiment, the security agent 420 takes natural language search or response commands as input, translates the responses/commands into API calls or queries (e.g., KQL queries), executes one or more tools, and retrieves the response based on given prompt.

With continued reference to FIG. 4, the illustrative embodiment provide an LLM based agent configured to comprehend and generalize analyst investigation actions and commands. This reasoning is then translated into reflections for threat hunting and investigation, which are stored in Long-term Memory. Further, the illustrative embodiments provide LLM-based threat hunting and investigation agents that incorporate these reflections into their operations. In some embodiments, the LLM based agent may be in the form of a co-pilot for security analysts. In some other embodiments, the LLM based agent may operate as a fully automated solution.

In an embodiment, the LLM-based agent is trained on extensive text data, which enables the security agent 420 to comprehend and respond to language inputs. An LLM agent can execute high verity of tasks, ranging from simple document summarization to complex reasoning and planning. Moreover, these agents have the ability to analyze information and draw logical conclusions. The example embodiments disclosed herein include leveraging an LLM agent to execute threat hunting and investigation procedures. In an embodiment, the security agent 420 utilizes security tools 410 to carry out its investigation and threat hunting tasks using natural language.

Further, in an embodiment, the LLM-based agent will leverages insights gathered from analysts and stored in its Long-Term Memory to automate investigation and threat hunting processes. These insights may serve various purposes, such as for example, guiding the next steps in an investigation based on past analyst actions, extracting observations derived from analyst reasoning in similar cases, and drawing conclusions. In some embodiments, the security agent 420 can function as a co-pilot for analysts. When security agent 420 recognizes familiar patterns or states, it may suggest a series of actions for the analyst to consider. For instance, the security agent 420 might recommend that the analyst check the credentials associated with a user who has recently logged into the system, based on past cases. The co-pilot agent can then execute these operations on behalf of the analyst and present the results. In some embodiments, the security agent 420 can operate as a fully autonomous system, handling the entire threat hunting and investigation process independently, including implementing response actions autonomously.

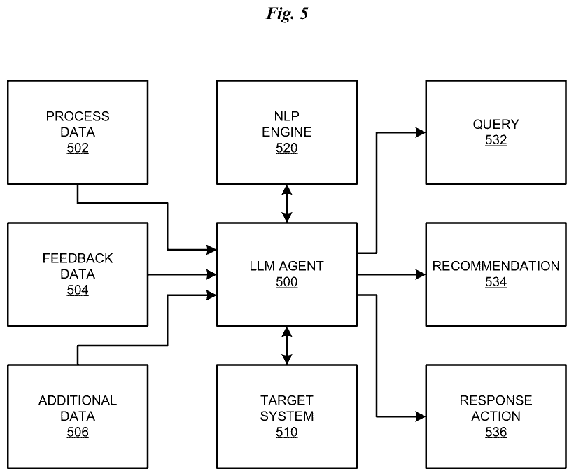

FIG. 5 depicts a block diagram of an example process for system security monitoring in accordance with an illustrative embodiment. In some embodiments, LLM agent 500 of FIG. 5 includes aspects of security agent module 200 of FIGS. 1 and 2, security agent module 300 of FIG. 3, and/or LLM based agent 420 of FIG. 4. In the illustrated embodiment, LLM agent 500 employs NLP engine 520 to analyze process data 502, feedback data 504, and/or additional data 506, combined with target system 510 features and/or characteristics, to generate outputs that include a query 532, recommendation 534, and/or automatic response actions 536.

In an embodiment, the process data 502, which may include, but is not limited to, event logs, system interactions, and historical actions, provides insights into the sequence of activities and behaviors within the system. Further, user feedback data 504 captures the analyst's responses, decisions, and feedback regarding system interactions and security incidents. Additional data 506 may include contextual information, system configurations, security policies, and environmental variables that influence security operations.

The NLP engine 520 aggregates data from various data sources described herein, combining process data 502, user feedback data 504, and additional data 506 with target system 510 characteristics to generate outputs tailored to the specific context and requirements of the target system 510. The NLP engine 520 leverages natural language processing techniques to analyze textual information, extract meaning, and derive insights from the data sources.

Based on this analysis, the NLP engine 520 generates queries 532 to seek further information from the analyst, prompting clarification or additional details regarding specific actions or decisions. Additionally, the NLP engine 520 formulates recommendations 534 based on the processed data and system characteristics. Furthermore, the NLP engine 520 may trigger automatic response actions 536 based on predefined rules, machine learning models, or historical patterns. In some embodiments, these automatic response actions are initiated in real-time to mitigate security threats, enforce security policies, or respond to critical incidents without additional manual intervention.

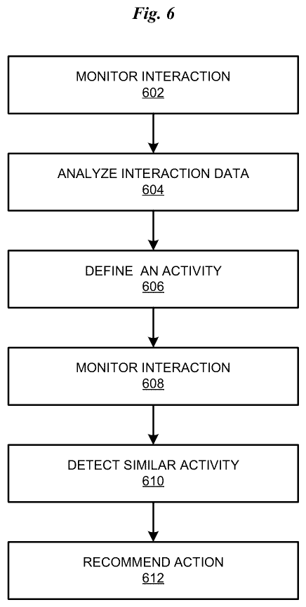

FIG. 6 depicts a flowchart of an example process for automated security monitoring, detection, and response initiation in accordance with an illustrative embodiment.

In an embodiment, at step 602, the process includes monitoring interactions within the system to capture event data, user actions, and system logs. This step aims to track the behavior and activities taking place within the system, providing a foundation for subsequent analysis and detection of security threats.

In an embodiment, at step 604, the process includes analyzing the interaction data collected at step 602. This analysis involves processing event logs, identifying patterns, anomalies, and trends, and extracting insights to understand the normal behavior and activities within the system. By analyzing the data, the system can gain a deeper understanding of user interactions and system events.

In an embodiment, at step 606, the process includes defining specific activities or behaviors within the system based on the analysis of interaction data. These defined activities serve as reference points for monitoring and detecting deviations from expected behavior, enabling the system to identify potential security threats or abnormal activities.

In an embodiment, at step 608, the process involves continuing to monitor interactions and activities within the system in real-time. This ongoing monitoring allows the system to track user actions, system events, and behavior patterns to detect any deviations from the defined activities. By monitoring interactions continuously, the system can promptly identify security incidents or suspicious behavior.

In an embodiment, at step 610, the process includes detecting activities that are similar to predefined patterns or known security threats. This detection mechanism compares current activities with historical data, security rules, or behavioral patterns to recognize potential security risks. By detecting similar activities, the system can proactively identify and respond to security threats in a timely manner.

In an embodiment, at step 612, the process involves recommending an appropriate action in response to the detected security threat. This recommendation may include alerting security personnel, blocking access, initiating a response plan, or implementing security measures to mitigate the identified threat effectively. By recommending actions based on detected threats, the system can enhance its security posture and respond swiftly to potential risks.

Embodiments of the process depicted by FIG. 6 include monitoring analyst activity to track their interactions, decisions, and behaviors within the system. By capturing event data, user actions, and system logs related to the analyst's activities, the system can gain insights into their typical behavior and patterns. This monitoring allows the system to establish a baseline of normal activities and detect deviations or anomalies that may indicate potential security risks or unauthorized actions.

Furthermore, the process involves recommending actions based on detected similar analyst activity. When the system identifies activities by an analyst that are similar to past analyst behavior, known security threats, suspicious behavior, or deviations from standard practices, it triggers a response mechanism to recommend appropriate actions. These recommendations may include alerting the analyst, escalating the issue to security personnel, initiating a response plan, or implementing security measures to address the identified risk effectively.

Further, embodiments of the process include detecting an issue that an analyst may be attempting to solve by comparing the analyst's actions to previous analysts'actions. This comparison allows the system to identify patterns and similarities in the analyst's behavior that may indicate an analyst's intentions to respond to a potential security threat. By analyzing historical data of previous analysts'actions and responses to similar issues, the system can predict the sequence of actions the current analyst is likely to take to address the identified problem.

Further, in some embodiments, based on the detected issue and the prediction of the analyst's sequence of actions, the system recommends auto-completing the analyst's sequence of actions to help address and solve the problem efficiently. These recommendations involve suggesting the next steps, automating certain actions, and providing guidance on the optimal course of action based on historical patterns and successful approaches taken by previous analysts in similar situations. The goal is to assist the analyst in navigating the response process seamlessly and ensuring a timely and effective resolution of the security threat.

By leveraging predictive analytics and historical data to anticipate the analyst's sequence of actions, the system can streamline the response process and enhance the analyst's decision-making capabilities. The auto-completion of the analyst's sequence of actions aims to optimize the response strategy, improve incident response times, and empower the analyst to address security threats proactively and effectively

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular

feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
executing a process mining technique to extract event data from a target system during a first interaction session across the target system, the event data comprising one or more events corresponding to one or more actions taken across the target system during the first interaction session;
generating, by computationally correlating the one or more events of the event data to each other, a behavior mapping, the behavior mapping defining a relationship between one or more intended actions, and one or more intended outcomes corresponding to the one or more intended actions;
generating a confidence score for the relationship between the one or more intended actions and the one or more intended outcomes, the confidence score based on a probability of correctness of the relationship between the one or more intended actions and the one or more intended outcomes;
generating a query for additional information related to the one or more intended actions upon a determination that the confidence score is below a predefined confidence score threshold; and
updating, by incorporating additional information provided in response to the query for additional information, the relationship between the one or more intended actions and the one or more intended outcomes defined by the behavior mapping.

2. The computer-implemented method of claim 1, further comprising:
monitoring the target system during a second interaction session to detect a similar activity detected during the first interaction session;
generating, upon detection of the similar activity, a recommendation based on the similar activity detected.

3. The computer-implemented method of claim 2, further comprising automatically initiating a responsive action within the target system upon acceptance of the recommendation generated based on the similar activity detected.

4. The computer-implemented method of claim 1, further comprising:
monitoring the target system during a second interaction session to detect a similar activity to an activity detected during the first interaction session;
analyzing the similar activity to detect a deviation between event data corresponding to the first interaction session and event data corresponding to the second interaction session;
generating a second query for additional information related to the one or more intended actions upon a detection of the deviation between event data corresponding to the first interaction session and event data corresponding to the second interaction session; and
updating, by incorporating the additional information provided in response to the second query for additional information, the relationship between the one or more intended actions and the one or more intended outcomes stored on the behavior mapping.

5. The computer-implemented method of claim 1, wherein the event data extracted from the target system during the first interaction session across the target system is processed by a large-language model to computationally predict the one or more intended actions and the one or more intended outcomes.

6. The computer implemented method of claim 1, wherein the query for additional information is displayed via a user interface as a natural language query, and the additional information provided in response to the query for additional information is input via the user interface.

7. A computer program product comprising one or more computer readable storage media, and program instructions collectively stored on the one or more computer readable storage media, the program instructions executable by a processor to cause the processor to perform operations comprising:
executing a process mining technique to extract event data from a target system during a first interaction session across the target system, the event data comprising one or more events corresponding to one or more actions taken across the target system during the first interaction session;
generating, by computationally correlating the one or more events of the event data to each other, a behavior mapping, the behavior mapping defining a relationship between one or more intended actions, and one or more intended outcomes corresponding to the one or more intended actions;
generating a confidence score for the relationship between the one or more intended actions and the one or more intended outcomes, the confidence score based on a probability of correctness of the relationship between the one or more intended actions and the one or more intended outcomes;
generating a query for additional information related to the one or more intended actions upon a determination that the confidence score is below a predefined confidence score threshold; and
updating, by incorporating additional information provided in response to the query for additional information, the relationship between the one or more intended actions and the one or more intended outcomes defined by the behavior mapping.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, further comprising:
monitoring the target system during a second interaction session to detect a similar activity detected during the first interaction session;
generating, upon detection of the similar activity, a recommendation based on the similar activity detected.

11. The computer program product of claim 10, further comprising automatically initiating a responsive action within the target system upon acceptance of the recommendation generated based on the similar activity detected.

12. The computer program product of claim 7, further comprising:
monitoring the target system during a second interaction session to detect a similar activity to an activity detected during the first interaction session;
analyzing the similar activity to detect a deviation between event data corresponding to the first interaction session and event data corresponding to the second interaction session;
generating a second query for additional information related to the one or more intended actions upon a detection of the deviation between event data corresponding to the first interaction session and event data corresponding to the second interaction session; and
updating, by incorporating the additional information provided in response to the second query for additional information, the relationship between the one or more intended actions and the one or more intended outcomes stored on the behavior mapping.

13. The computer program product of claim 7, wherein the event data extracted from the target system during the first interaction session across the target system is processed by a large-language model to computationally predict the one or more intended actions and the one or more intended outcomes.

14. The computer program product of claim 7, wherein the query for additional information is displayed via a user interface as a natural language query, and the additional information provided in response to the query for additional information is input via the user interface.

15. A computer system comprising a processor and one or more computer readable storage media, and program instructions collectively stored on the one or more computer readable storage media, the program instructions executable by the processor to cause the processor to perform operations comprising:
executing a process mining technique to extract event data from a target system during a first interaction session across the target system, the event data comprising one or more events corresponding to one or more actions taken across the target system during the first interaction session;
generating, by computationally correlating the one or more events of the event data to each other, a behavior mapping, the behavior mapping defining a relationship between one or more intended actions, and one or more intended outcomes corresponding to the one or more intended actions;
generating a confidence score for the relationship between the one or more intended actions and the one or more intended outcomes, the confidence score based on a probability of correctness of the relationship between the one or more intended actions and the one or more intended outcomes;
generating a query for additional information related to the one or more intended actions upon a determination that the confidence score is below a predefined confidence score threshold; and
updating, by incorporating additional information provided in response to the query for additional information, the relationship between the one or more intended actions and the one or more intended outcomes defined by the behavior mapping.

16. The computer system of claim 15, further comprising:
monitoring the target system during a second interaction session to detect a similar activity detected during the first interaction session;
generating, upon detection of the similar activity, a recommendation based on the similar activity detected.

17. The computer system of claim 16, further comprising automatically initiating a responsive action within the target system upon acceptance of the recommendation generated based on the similar activity detected.

18. The computer system of claim 15, further comprising:
monitoring the target system during a second interaction session to detect a similar activity to an activity detected during the first interaction session;
analyzing the similar activity to detect a deviation between event data corresponding to the first interaction session and event data corresponding to the second interaction session;
generating a second query for additional information related to the one or more intended actions upon a detection of the deviation between event data corresponding to the first interaction session and event data corresponding to the second interaction session; and
updating, by incorporating the additional information provided in response to the second query for additional information, the relationship between the one or more intended actions and the one or more intended outcomes stored on the behavior mapping.

19. The computer system of claim 15, wherein the event data extracted from the target system during the first interaction session across the target system is processed by a large-language model to computationally predict the one or more intended actions and the one or more intended outcomes.

20. The computer system of claim 15, wherein the query for additional information is displayed via a user interface as a natural language query, and the additional information provided in response to the query for additional information is input via the user interface.
